(19) United States
(12) Patent Application Publication
(10) Pub. No.: US 2011/0065313 A1
(43) Pub. Date: Mar. 17, 2011

(54) POWER CORD COLLECTOR FOR POWER SUPPLY

(76) Inventor: Ming-Jhih Huang, Taipei County (TW)

(21) Appl. No.: 12/559,482

(22) Filed: Sep. 14, 2009

(51) Int. Cl. H01R 13/72

(52) U.S. Cl. 439/501

(57) ABSTRACT

A power cord collector for power supply includes a cover body and collecting portion. The cover body has a rectangular space for receiving the case of the power supply. Cord outlets are formed to two opposite lateral walls of the cover body. The collecting portion has two flexible walls which are symmetrically extended from a top and bottom surface of the cover body. The two walls are bent towards each other, and a gap is formed where the walls touching. A circular space is formed within the two walls for collecting the power cords. Open holes are formed to the gap, and the positions of the open holes are corresponding to the cord outlets. The power cords of the power supply received by the cover body will pass through cord outlets formed to the cover body to be connected to a plug or an electric device.

### FIELD OF THE INVENTION

The present invention relates to cord collector for electric device, and particular to a portable power cord collector for power supply.

### DESCRIPTION OF THE PRIOR ART

Electric devices usually use transformer, regulator to stabilize power for their operation. Such power supplies will be carried with their portable devices like a laptop, cell phone, video camera. Common power supply usually sizes like a palm and has two power cords on two ends thereof. The power cords are usually wound around the case or tied as a bundle for carrying. Such handling is inconvenient and the metal wires inside the cover of the cord are easily broken by sharp curves. The broken wires will cause loss of power transmission. The long coiled power cords is an interference while using, the extra cords on the ground are usually dusty and a safety issue.

### SUMMARY OF THE PRESENT INVENTION

Accordingly, the primary object of the present invention is to provide a power cord collector for power supply to protect the case of the power supply by a cover body and to protect and retrieve the power cords by a collecting portion. The case of the power supply can be received by the cover body and the power cords can be wound around or drawn out from the collecting portion so as to provide a tidy appearance and convenience of portability.

To achieve above object, the present invention provides a power cord collector having a cover body and a collecting portion. The cover body has a rectangular space for receiving the case of the power supply. Cord outlets are formed to two opposite lateral walls of the cover body. The cover body is elastic so that the case of the power supply is easily fixed in the cover body. The collecting portion has two flexible walls which are symmetrically extended from a top and bottom surface of the cover body. The two walls are bent towards each other, and a gap is formed to a position where the walls touch. A circular space is formed within the two walls for collecting a power cord. Open holes are formed to the gap, and the positions of the open holes are corresponding to the cord outlets. The power cords of the power supply received by the cover body will pass through cord outlets formed to the cover body to connect a plug or an electric device. By the gap of the collecting portion, the power cords can be retrieved into or drawn out from the collecting portion. Therefore, the power cords retrieved in the collecting portion will not be broken by sharp curves. The power cords are completely covered by the collecting portion so as to provide a tidy appearance and convenience of portability, friction and dust to the power cords are also avoided. Preferably, a thickened lip is formed to a peripheral of both flexible walls so that the frequently operations of retrieving and drawing of the power cords will damage the gap. The mentioned cover body and the collecting portion are preferably made integral by material such as rubber or silica gel so as to have a better property of elasticity and flexibility.

### BRIEF DESCRIPTION OF THE DRAWINGS

FIG. 1 is a schematic view showing an appearance of the present invention.

FIG. 2 is a partial cross section view of a top side of the present invention.

FIG. 3 is a lateral view of the present invention.

FIG. 4 is a cross section view from the A-A line in the FIG. 2.

FIG. 5 is a cross section view from the B-B line in the FIG. 2.

FIG. 6 is a partial cross section view of a top side of the present invention with a power supply received inside thereof.

FIG. 7 is a schematic view showing the present invention with the power supply and the retrieved power cords inside thereof, and

FIG. 8 is a partial cross section view of a top side of the present invention with the power supply and the retrieved power cords inside thereof.

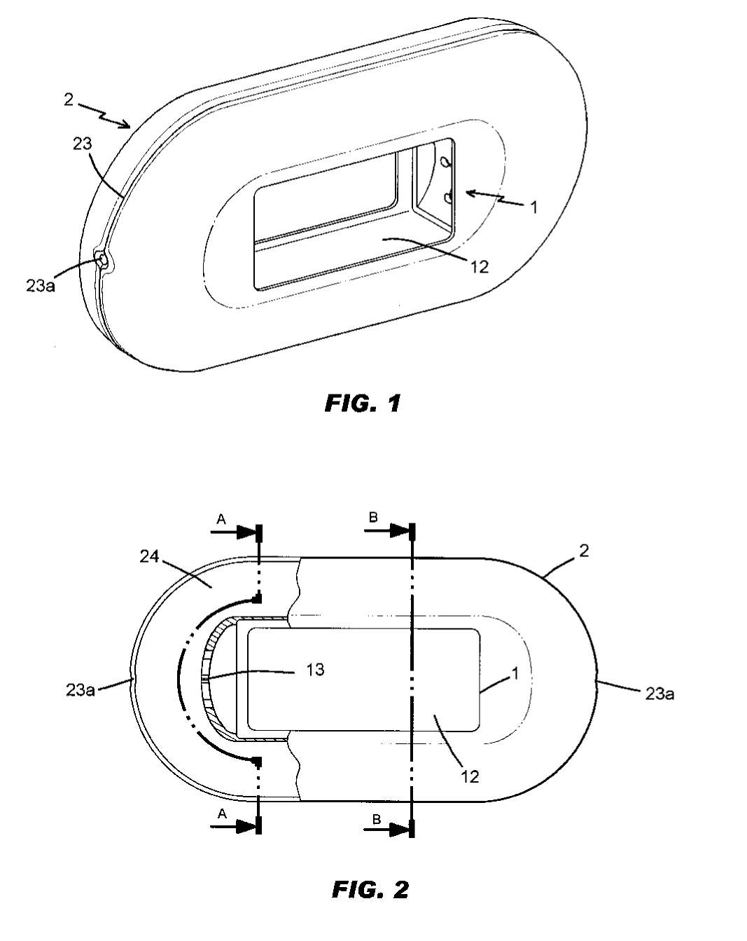

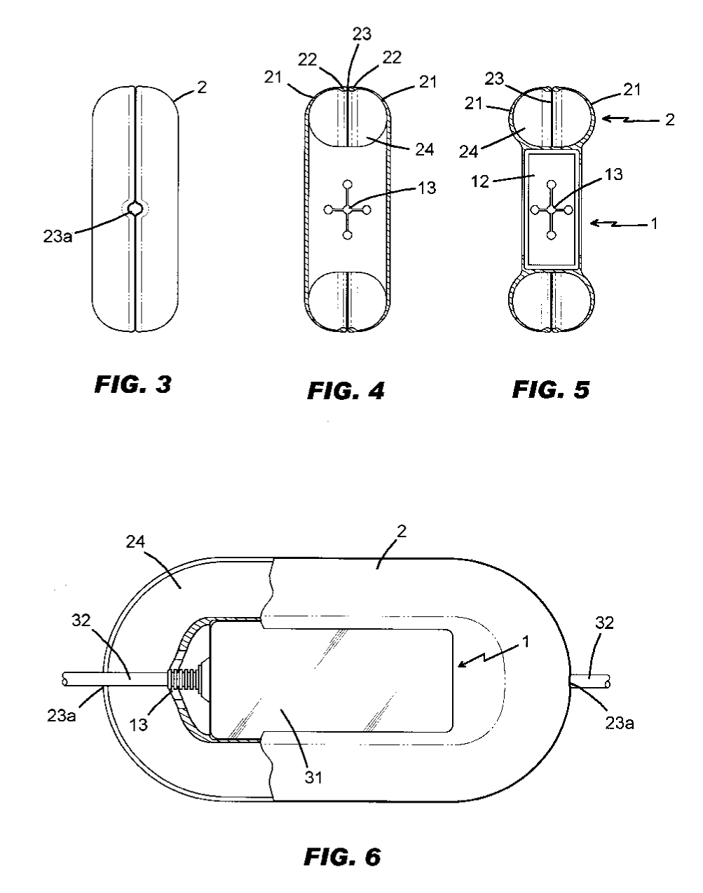

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A preferable embodiment of the present invention is illustrated in the attached drawings. A power cord collector for power supply includes a cover body 1 and collecting portion 2 formed integral by rubber so that they are flexible and elastic. The cover body 1 has a rectangular space 12 for receiving the case of the power supply. On the two opposite walls of the space 12, a cord outlet 13 with a shape of an approximately cross is formed separately for passing by the power cord of the power supply. The collecting portion 2 has two flexible walls 21 which are symmetrically extended from a top and bottom surface of the cover body. A round peripheral of the extended wall 21 is thickened as a lip 22. The two walls 21 are bent towards each other, and a gap 23 is formed where the walls touching. A circular space 24 for collecting the power cords is thus formed around the cover body 1 by the walls 21. A open hole 23a corresponding to the cord outlet 13 is formed to the gap 23.

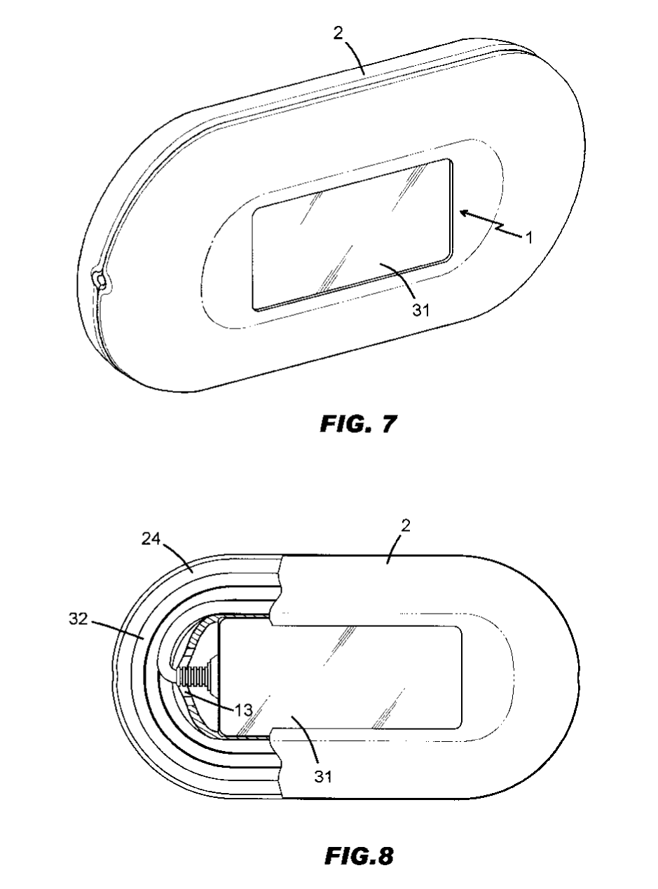

Referring to FIG. 8, a case 31 of a power supply is put into and fixed in the rectangular space 12 by the elastic cover body 1. Referring to FIG. 6, power cords of the power supply can pass through the cord outlets 13 and can be pulled out from the open holes 23a of the collecting portion 2 so as to be plugged into a plug or electric device. Referring to FIGS. 7 and 8, the power cord 32 of the power supply can be retrieved in the collecting portion 2 by winding the cord 32 around the circular space 24 through the gap 23. The power cord 32 can also be drawn out of the collecting portion 2. The power cord 32 is smoothly wound around the circular space 24 so as to prevent damages by deforming and bending. Moreover, the flexible walls 21 will shelter the power cords inside the collecting portion 2 from dust and abrasion and provide a tidy outer appearance and convenience of portability. The cords can be drawn out from the collecting portion 2 with a proper length so as to prevent disturbance of the long extra cords.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A power cord collector for power supply comprising:
a cover body having a rectangular space for receiving a case of a power supply; power cord outlets being formed to lateral walls of the cover body;
a collecting portion having two flexible walls symmetrically extending from a top and bottom surface of the cover body; the two walls bending towards each other, a gap being formed to a position where the walls touching; a circular space being formed within the two walls for collecting power cords of the power supply;
wherein the power cords of the power supply received by the cover body will pass through cord outlets formed to the cover body to be connected to a plug or an electric device; by the gap of the collecting portion, the power cords will be retrieved or drawn out.

2. The power cord collector for power supply as claimed in claim 1, wherein the cover body is elastic.

3. The power cord collector for power supply as claimed in claim 1, wherein the cover body and the collecting portion is formed integral by material of one of a rubber or silica gel.

4. The power cord collector for power supply as claimed in claim 1, wherein a peripheral of the flexible wall is thickened as a lip.

5. The power cord collector for power supply as claimed in claim 1, wherein open holes are formed to the gap; the positions of the open holes are opposite to the cord outlets.
